(19) United States
(12) Patent Application Publication
(10) Pub. No.: US 2022/0019219 A1
(43) Pub. Date: Jan. 20, 2022

(54) CONTROL UNIT AND AUTONOMOUS FUNCTIONING SYSTEM

(71) Applicant: YAMAHA HATSUDOKI KABUSHIKI KAISHA, Iwata-shi (JP)

(72) Inventors: Yuji HIRAMATSU, Shizuoka (JP); Keiji NISHIMURA, Shizuoka (JP); Hirokatsu MURAMATSU, Shizuoka (JP)

(21) Appl. No.: 17/490,658

(22) Filed: Sep. 30, 2021

Related U.S. Application Data
(63) Continuation-in-part of application No. PCT/JP2020/014545, filed on Mar. 30, 2020.

(30) Foreign Application Priority Data
Apr. 1, 2019 (JP) PCT/JP2019/014441

(51) Int. Cl. G05D 1/00; H04N 7/18; G05D 1/02

(52) U.S. Cl. CPC G05D 1/0038; H04N 7/185; G05D 1/0212; G05D 1/0088; G05D 1/0094; G05D 1/0246

(57) ABSTRACT

A control unit for an autonomous functioning apparatus that has a sensor, an external image-capturing camera and an actuator, and is manipulable by a remote manipulation device. The control unit is connected to a remote communication device that is connected to a cooperative control unit for controlling a cooperative functioning apparatus. The remote manipulation device is positioned outside the autonomous functioning apparatus and the cooperative functioning apparatus. The control unit includes an external image connector for receiving external image data, a functioning control connector for outputting a functioning control signal for controlling functioning of the actuator, an external communication connector for exchanging data with the remote communication device, and a functioning control device for outputting monitor image data to the remote manipulation device, based on a signal outputted from the remote manipulation device, the cooperative control unit, or the sensor. The monitor image data is based on the external image data.

### CROSS-REFERENCE TO RELATED APPLICATIONS

This is a continuation-in-part application of International Application PCT/JP2020/014545 filed on Mar. 30, 2020, which claims priority from an International Application PCT/JP2019/014441, filed on Apr. 1, 2019. The contents of the applications are incorporated herein by reference.

### TECHNICAL FIELD

The present teaching relates to a control unit for an autonomous functioning apparatus and an autonomous functioning system comprising the control unit.

### BACKGROUND ART

An autonomous functioning apparatus comprising a camera and functions based on an image captured by the camera is known.

For example, Patent Document 1 describes a working robot. The working robot recognizes an image captured by a camera, and based on the result of such image recognition, the working robot controls the drive power output from a working motor. This allows the working robot to perform complicated work autonomously.

### CITATION LIST

### Patent document

[Patent Document 1] Japanese Unexamined Patent Publication No. 2018-7615

### SUMMARY OF INVENTION

### Technical Problem

It is desired that complication of a configuration is suppressed or avoided and a much wider variety of work is performed in an autonomous functioning apparatus that functions based on an image captured by a camera.

It is an objective of the present teaching to provide a control unit for an autonomous functioning apparatus capable of suppressing or avoiding complication of a configuration and of performing a much wider variety of work.

### Solution to Problem

The present inventors have considered in view of the problems described above to obtain the following understandings.

Combining a plurality of autonomously functionable apparatuses is one possible way to perform more complicated work. For example, an autonomous working apparatus with a sensor for working control is coupled to an autonomous traveling vehicle with a camera for traveling control.

Such an apparatus can, for example, perform precise work based on recognition of an image captured by the camera for working control while the vehicle is traveling precisely based on recognition of an image captured by the camera for traveling control.

However, it is sometimes impossible to perform work only by autonomous processing based on an image in a location where an apparatus actually works. Difficulties in performing work only by autonomous processing based on an image are found, for example, when there is an obstacle that was not expected at the start of work on a traveling route of an autonomous vehicle. Such a case is more likely to happen as the work is more complicated. In order to address such a case, an autonomous functioning apparatus can be configured so as to have additional autonomous processing. For example, the autonomous functioning apparatus can be configured to have autonomous processing based on the result of the advanced sensing other than the image when difficulties in performing work only by autonomous processing based on an image are found in order to overcome the case. Unfortunately, this may lead to complicated configurations.

Providing a remote manipulation device for remotely functioning a working apparatus is another possibility to deal with the case where the work cannot be performed only by autonomous processing. In addition, a camera provided in the working apparatus can be used for remote manipulation. For example, by transmitting an image captured by a camera to the remote manipulation device, an operator performs remote manipulation while watching the image of the camera displayed on the remote manipulation device. This may allow dealing with a case where the work is difficult to be performed only by autonomous processing based on an image while suppressing or avoiding the complication of the configuration. However, such a way of dealing can involve the following problems in order to be made feasible.

A complicated remote manipulation device could be required if images from cameras with different roles correspond to the display part of the remote manipulation device. The use of such a complicated remote manipulation device makes preparation and installation for remote manipulation troublesome. In addition, the image data is significantly larger than, for example, information of a distance sensor or a position sensor. Consequently, when the image data from the camera is transmitted, the transmitted data becomes enormous, and an image required for operation may be disturbed or transmitted with delay due to, for example, a restriction of communication, which causes problems in operation.

Accordingly, there can be provided a control unit for an autonomous functioning apparatus that makes preparation and installation of the remote manipulation device easier and that suppresses the aforementioned negative influences caused by the restriction of communication. With such a control unit, complication of its configuration could be suppressed or avoided, and the control unit could enable an operator to appropriately deal with, by remotely manipulating while watching images, a case in which work can be performed only by autonomous processing based on an image. As a result, the complication of the configuration can be suppressed or avoided, and allowing other, more complicated work to be performed. Consequently, complication of a configuration can be suppressed or avoided, and a much wider variety of work can be performed.

In order to achieve the objective described above, according to one aspect of the present teaching, a control unit comprises as follows:

(1) A control unit for an autonomous functioning apparatus having a sensor, an external image-capturing camera for capturing an external environment, and an actuator, the autonomous functioning apparatus being autonomously functionable based on an external image and manipulable by operation of a remote manipulation device, the control unit being connected to one remote communication device, the one remote communication device being connected to a cooperative control unit for at least one cooperative functioning apparatus coupled to the autonomous functioning apparatus,

the control unit comprising:

an external image connector for inputting external image data representing an image-capturing result obtained by the external image-capturing camera;

a functioning control connector for outputting a functioning control signal for controlling the functioning of the actuator;

an external communication connection part, where data is inputted from and outputted to the one remote communication device communicatively connected to the remote manipulation device; and

a functioning control device for outputting monitor image data from the external communication connection part through the one remote communication device to the remote manipulation device based on a signal outputted from:
the remote manipulation device;
the cooperative control unit; or
the sensor,
   under the circumstance where the cooperative control unit for controlling the cooperative functioning apparatus is connected to the one remote communication device, the monitor image data being based on the external image data inputted through the external image connector, the remote manipulation device being positioned outside both the autonomous functioning apparatus and the cooperative functioning apparatus, the sensor being provided in the autonomous functioning apparatus.

The functioning control device outputs monitor image data, which is based on the external image data representing the image-capturing result obtained by the external image-capturing camera, to the remote communication device through the external communication connection part. The monitor image data can be transmitted from the remote communication device to the remote manipulation device and displayed.

The cooperative control unit for the cooperative functioning apparatus is also connected to the remote communication device. The monitor image data for receiving the image data and displaying the image is outputted to the remote manipulation device based on the signal from the remote manipulation device, the cooperative control unit, and the sensor provided in the autonomous functioning apparatus. For example, the output of the monitor image data is started or stopped based on the signal from the remote manipulation device, the cooperative control unit, and the sensor provided in the autonomous functioning apparatus. Alternatively, the amount of the monitor image data is changed based on the signal from the remote manipulation device, the cooperative control unit, and the sensor provided in the autonomous functioning apparatus. For example, an image can be adjusted by compressing, superimposing, combining, switching, or cropping, and then outputted to one remote communication device. As a result, an image corresponding to the state of the remote manipulation device, the cooperative control unit, or the autonomous functioning apparatus is displayed on the remote manipulation device, which allows more complicated work to be performed based on an image corresponding to the state of the apparatus or the desired functions. Thus, a much wider variety of work can be performed.

Further, for example, when the remote communication device transmits the external image data from the functioning control device to the remote manipulation device, the amount of data transmitted from the cooperative functioning apparatus tends to increase. The functioning control device outputs the monitor image data that is based on the external image data inputted through the external image connector to the remote communication device based on the signal from the remote manipulation device, the cooperative control unit, and the sensor provided in the autonomous functioning apparatus. Accordingly, image data outputted to the remote manipulation device through the remote communication device can be outputted in response to the signal from the remote manipulation device, the cooperative control unit, or the sensor provided in the autonomous functioning apparatus. For example, each image can be adjusted by compressing, superimposing, combining, switching, or cropping, and then outputted to the one remote communication device. Consequently, complication of a configuration of the remote manipulation device for receiving the image data and displaying the image can be suppressed or avoided. This makes preparation and installation of the remote manipulation device easier. Moreover, the aforementioned negative influences caused by the restriction of communication outputted to the remote manipulation device can be suppressed.

According to one aspect of the present teaching, the control unit can comprise as follows:

(2) The control unit according to (1), wherein

the actuator provided in the autonomous functioning apparatus is a traveling device configured to travel the autonomous functioning apparatus, and the functioning control device generates a functioning control signal that instructs the traveling course of the autonomous functioning apparatus by processing the external image data.

According to the control unit comprising as described above, the autonomous functioning apparatus works as an autonomous traveling vehicle. When images regarding an autonomous traveling vehicle are displayed for remote manipulation, complication of the configuration of the remote manipulation device can be suppressed or avoided while the images required for manipulation of the vehicle are displayed. Thus, complication of the configuration of the remote manipulation device for manipulating the autonomous traveling vehicle can be suppressed or avoided, and a much wider variety of work including traveling of an autonomous traveling vehicle can be performed.

According to one aspect of the present teaching, the control unit can comprise as follows:

(3) The control unit according to (1) or (2), wherein

the functioning control device outputs monitor image data based on:
a signal outputted from the remote communication device and inputted through the external communication connection part in response to a request to transmit an image inputted from the remote manipulation device to the remote communication device;
a signal outputted from the cooperative control unit; or
a signal outputted from the sensor,
   the monitor image data, by processing of the external image data inputted from the external image-capturing camera, having a smaller amount of data than the external image data.

According to the control unit comprising as described above, monitor image data having a smaller amount of data than the external image data inputted from the external image-capturing camera is outputted. Accordingly, an image required for manipulating the cooperative functioning apparatus can be displayed while suppressing the aforementioned negative influences caused by the restriction of communication. Thus, complication of the configuration of the remote manipulation device can be suppressed or avoided, and a much wider variety of work can be performed.

According to one aspect of the present teaching, the control unit can comprise as follows:

(4) The control unit according to any one of (1) to (3), wherein

the functioning control device outputs monitor image data based on:
a signal outputted from the remote communication device and inputted through the external communication connection part in response to a request for transmitting an image inputted from the remote manipulation device to the remote communication device;
a signal outputted from the cooperative control unit; or
a signal outputted from the sensor,
   the monitor image data, by compressing of the external image data inputted from the external image-capturing camera, having a smaller amount of data than the external image data.

According to the control unit comprising as described above, since it performs image compression processing on external image data, the amount of data can be reduced while narrowing the displayed range or suppressing of broadening the displayed updated-time-interval. Such a unit can suppress the aforementioned negative influences caused by the restriction of communication while suppressing the image to be less clear.

According to one aspect of the present teaching, the control unit can comprise as follows:

(5) The control unit according to any one of (1) to (4), wherein

the functioning control device outputs monitor image data based on:
a signal outputted from the remote communication device and inputted through the external communication connection part in response to a request for transmitting an image inputted from the remote manipulation device to the remote communication device;
a signal outputted from the cooperative control unit; or
a signal outputted from the sensor,
   the monitor image data, by frame thinning process on the external image data inputted from the external image-capturing camera, having a smaller amount of data than the external image data.

According to the control unit comprising as described above, the aforementioned negative influences caused by the restriction of communication can be suppressed without reducing the resolution of the image.

According to one aspect of the present teaching, the control unit can comprise as follows:

(6) The control unit according to any one of (1) to (5), wherein

the functioning control device outputs monitor image data based on:
a signal outputted from the remote communication device and inputted through the external communication connection part in response to a request for transmitting an image inputted from the remote manipulation device to the remote communication device;
a signal outputted from the cooperative control unit; or
a signal outputted from the sensor,
   the monitor image data, by crop process for extracting an image of a part of a region from the external image data inputted from the external image-capturing camera, having a smaller amount of data than the external image data.

According to the control unit comprising as described above, the aforementioned negative influences caused by the restriction of communication can be suppressed by means of crop processing without reducing the resolution of the image region of interest.

According to one aspect of the present teaching, the autonomous functioning system can comprise as follows:

(7) The control unit according to any one of (1) to (6), wherein the sensor (111) provided in the autonomous functioning apparatus (1) is the external image-capturing camera.

According to the control unit comprising as described above, the monitor image data of the external image-capturing camera can be outputted to the remote manipulation device through the remote communication device based on the contents of the image captured by the external image-capturing camera provided in the autonomous functioning apparatus. Images of which contents are suitable for output to the remote manipulation device can be outputted. Consequently, the aforementioned negative influences caused by the restriction of communication outputted to the remote manipulation device can be suppressed.

According to one aspect of the present teaching, the autonomous functioning system can comprise as follows:

(8) The control unit according to any one of (1) to (7), wherein the cooperative functioning apparatus comprises a cooperative functioning apparatus camera that is connected to the cooperative control unit and outputs cooperative image data, which is an image-capturing result of an external environment, wherein

the functioning control device selects data to be outputted to the remote manipulation device among:
the external image data inputted through the external image connector; and
the cooperative image data outputted from the cooperative functioning apparatus camera and inputted through the cooperative control unit,
   based on a signal outputted from:
the remote manipulation device that is positioned outside the autonomous functioning apparatus and the cooperative functioning apparatus;
the cooperative control unit; or
   the sensor provided in the autonomous functioning apparatus.

When the remote communication device transmits both data based on the external image data from the functioning control device and data based on the cooperative image data from the cooperative functioning apparatus to the remote manipulation device, the amount of data transmitted from the cooperative functioning apparatus tends to increase. According to one aspect of the present teaching, images suitable for the functioning state that are selected among the images of the cooperative functioning apparatus camera and the images of the external image-capturing camera can be outputted to the remote manipulation device. Thus, more complicated work can be performed, and the aforementioned negative influences caused by the restriction of communication outputted to the remote manipulation device can be suppressed.

According to one aspect of the present teaching, the autonomous functioning system can comprise as follows:

(9) An autonomous functioning system that is autonomously functionable based on an external image and remotely manipulable based on operation of a remote manipulation device (3), the autonomous functioning system comprising:

an autonomous functioning apparatus; and

a cooperative functioning apparatus coupled to the autonomous functioning apparatus,

wherein the cooperative functioning apparatus comprises a cooperative control unit for controlling,

the autonomous functioning apparatus comprising:

an external image-capturing camera provided in the autonomous functioning apparatus for capturing an external environment;

a sensor provided in the autonomous functioning apparatus;

an actuator controlled based on the external image;

a remote communication device (13) connected to the cooperative control unit; and

a control unit connected to the remote communication device,

the control unit (10) comprising:

an external image connector (110) for inputting external image data representing an image-capturing result obtained by the external image-capturing camera (11);

a functioning control connector (130) for outputting a functioning control signal for controlling the functioning of the actuator (121);

an external communication connection part (140), where data is inputted from and outputted to the remote communication device (13) communicatively connected to the remote manipulation device (3); and

a functioning control device (160) for outputting monitor image data from the external communication connection part (140) through the remote communication device (13) to the remote manipulation device (3) based on a signal outputted from:
the remote manipulation device (3);
the cooperative control unit (20); or
the sensor (111),
   under the circumstance where the cooperative control unit (20) for controlling the cooperative functioning apparatus (2) is connected to the remote communication device (13), the monitor image data being based on the external image data inputted through the external image connector (110), the remote manipulation device being positioned outside both the autonomous functioning apparatus and the cooperative functioning apparatus, the sensor being provided in the autonomous functioning apparatus.

According to the autonomous functioning system comprising as described above, when remote manipulation is performed by using the remote manipulation device, the images from a plurality of apparatuses included in the autonomous functioning system can be displayed by one remote manipulation device. Accordingly, complication of the configuration of the remote manipulation device can be suppressed or avoided. Preparation and installation of the remote manipulation device can be easier. More complicated work can be performed based on the images displayed on the remote manipulation device. Thus, a much wider variety of work can be performed. Moreover, the aforementioned negative influences caused by the restriction of communication of image data outputted to the remote manipulation device can be suppressed by regulating the amount of data of the images.

The terminology used herein is for the purpose of describing particular embodiments only and is not intended to limiting of the invention.

As used herein, the term “and/or” includes any or all combinations of one or more of the related listed items.

As used herein, the use of the term “including” “comprising” or “having” and variations thereof specifies the presence of the described features, steps, operations, elements, components, and/or equivalents thereof, but may include one or more of the steps, operations, elements, components, and/or groups thereof.

As used herein, the terms “mounted”, “connected”, “coupled” and/or their equivalents are broadly used and encompass both direct and indirect mounting, connecting, and coupling. Further, the “connected” and “coupled” are not restricted to physical or mechanical connections or couplings, but may include direct or indirect electrical connections or couplings.

Unless otherwise defined, all terms used herein (including technical and scientific terms) have the same meaning as commonly understood by one of ordinary skill in the art to which the invention belongs.

Terms such as those defined in commonly used dictionaries should be interpreted as having a meaning consistent with the meaning in the context of the relevant art and the present disclosure, and will not be interpreted in an idealized or overly formal sense unless explicitly defined herein.

It is understood that a plurality of techniques and steps are disclosed in the description of the present teaching.

Each of these has an individual advantage, and each can be used with one or more, or in some cases all, of the other disclosed techniques.

Accordingly, for the sake of clarity, this description will refrain from unnecessarily repeating all possible combinations of individual steps.

Nevertheless, the specification and claims should be read with the understanding that all such combinations are within the scope of the present teaching and claims.

A new control unit is described herein.

In the following description, for purposes of illustration, numerous specific details are set forth to provide a complete understanding of the present teaching.

However, it will be apparent to those skilled in the art that the present teaching can be practiced without these specific details.

The present disclosure should be considered as an example of the present teaching, and is not intended to limit the present teaching to the particular embodiments illustrated by the following figures or description.

One example of the autonomous functioning apparatus is an autonomous vehicle. It is noted that the autonomous functioning apparatus is not particularly limited, and may be, for example, an autonomous working robot.

The cooperative functioning apparatus for cooperating with the autonomous functioning apparatus is an autonomous working robot provided in an autonomous vehicle. It is noted that the cooperative functioning apparatus is not limited to this, and may be, for example, an autonomous vehicle provided with an autonomous working robot as an autonomous vehicle.

The control unit controls the actuator based on, for example, an external environment captured by the external image-capturing camera or an external environment captured by the cooperative functioning apparatus camera. In addition, the control unit may control the actuator based on, for example, an external environment captured by the external image-capturing camera and an external environment captured by the cooperative functioning apparatus camera.

One remote communication device means only one remote communication device. However, the control unit may comprise a communication device other than the one remote communication device. The control unit (that is, the functioning control device) and the cooperative control unit perform processing for image transmission so that the monitor image data in response to a request for image transmission is outputted from the one remote communication device while the condition of X<Y+Z is satisfied. At this time, each of the control unit and the cooperative control unit may receive a request for image transmission and perform processing for the image transmission independently of each other. In addition, one of the control unit and the cooperative control unit may receive a request for image transmission and perform processing for the image transmission while transmitting an instruction for image transmission to the other. In this case, the other unit performs processing for the image transmission based on the instruction. Here, X represents the amount of data communication per unit time of the monitor image data outputted from one remote communication device to the remote manipulation device. Y represents the amount of data communication per unit time of external image data inputted from the external image-capturing camera to the control unit. Z represents the amount of data communication per unit time of the cooperative image data inputted from the cooperative functioning apparatus camera to the cooperative control unit.

The remote communication device is the device that the image is inputted from the functioning control device of the control unit and the cooperative control unit, and transmits data to the remote manipulation device. The remote communication device is, for example, a combination of a data hub device and a communication device. The data hub device receives data from both the functioning control device of the control unit and the cooperative control unit and outputs the data to the communication device. The communication device transmits the outputted data to the remote manipulation device. The remote communication device may, for example, have a function of reducing the amount of data. The remote communication device, for example, reduces the amount of data by reducing image resolution. The method by which the remote communication device reduces the amount of data is not particularly limited, and for example, the amount of data may be reduced by limiting the displayed region of the image, that is, by cropping a partial region of the screen. For example, the remote communication device may reduce the amount of data by reducing the frame rate. However, the remote communication device may, for example, transmit the inputted data as it is without reducing the amount of data.

Further, the remote communication device may reduce the amount of data by combining a plurality of mutually different images into a region corresponding to one screen. For example, the remote communication device divides a region corresponding to one screen into a plurality of regions, and displays an image of the cooperative functioning apparatus camera and an image of the autonomous functioning apparatus camera on each of the region. In addition, the remote communication device can, for example, combine by displaying images from one camera on each region at each time.

The remote communication device is, for example, connected to the remote manipulation device so as to be able to communicate wirelessly, and is physically away from the remote manipulation device. However, the remote communication device may be, for example, connected to the remote manipulation device so as to be capable of wired communication. An image request signal outputted from the remote manipulation device to the remote communication device in the embodiment described later is one example of a request for transmission of an image. The request for transmission of the image is not limited to the request for transmitting the image, and may be, for example, a request for the specification of the image to be transmitted. The specification of the image is not particularly limited. The specification of the image includes, for example, a compression rate, a frame rate, an object to be captured, and a range to be captured. The remote manipulation device is one example of a communication apparatus positioned outside both the autonomous functioning apparatus and the cooperative functioning apparatus. In other words, when the remote manipulation device and another communication apparatus are positioned outside both the autonomous functioning apparatus and the cooperative functioning apparatus, the other communication apparatus may transmit a request for transmission of an image to the remote communication device, and the remote communication device may transmit monitor image data to the remote manipulation device. In this way, a request for transmission of an image is not absolutely necessary to be transmitted from the remote manipulation device.

The functioning control device outputs monitor image data based on the signal outputted from the cooperative control unit or the sensor. The signal outputted from the cooperative control unit is the one, for example, that is based on a result of detection by the cooperative sensing unit of the cooperative functioning apparatus. The signal outputted from the sensor is the one, for example, that represents the approach of the autonomous functioning apparatus to an external object if the sensing unit or the sensor is an approaching sensor. It is noted that the signal outputted from the cooperative control unit or the sensor is not particularly limited, and may be, for example, the signal representing detection of contact, the signal representing temperature, or the signal representing the progress of work. One example of the sensor of the autonomous functioning apparatus is the external image-capturing camera.

When the apparatus is provided with an actuator, the actuator is, for example, a motor. The actuator causes the autonomous functioning apparatus to perform physical output. An actuator provided in the cooperative functioning apparatus causes the cooperative functioning apparatus to perform physical output. The actuator may be an electromagnetic solenoid. The actuator is controlled by the functioning control device. The actuator may be directly controlled by the functioning control device. The actuator and the functioning control device may be indirectly controlled through a control means different from the functioning control device. In this case, the functioning control device controls the control means, and the control means controls the actuator.

The control unit is, for example, a navigation device for controlling the autonomous driving of the autonomous vehicle. However, the control unit is not particularly limited, and may be configured to control a robot that does not travel.

The control unit used for the autonomous functioning apparatus is, for example, provided in the autonomous functioning apparatus. However, the position in which the control unit is provided is not particularly limited, and for example, the control unit may be installed at a position away from the autonomous functioning apparatus and may be communicatively connected to the peripheral apparatuses through respective connectors. Each of “the external image connector,” “the functioning control connector, “the external communication connector,” is an electric connector.

The communicable connections are, for example, electrically connected directly through connectors and electrical wires. However, the means of communicable connections is not particularly limited, and may be, for example, disposed at a position that is physically away and capable of communication through a wireless communication device. The communicable connections may also be communicable through a central communication relay device that can communicate with many devices.

The number of cooperative control units connected to one remote communication device is not limited to one. For example, a control unit and a plurality of cooperative control units may be connected to one remote communication device. When the autonomous functioning system includes, for example, a plurality of cooperative functioning apparatuses, a control unit and a plurality of cooperative control units are connected to one remote communication device.

The control unit is constituted by, for example, a combination of a graphics processing unit (GPU) and a field programmable gate array (FPGA). However, the control unit can be, for example, constituted by an FPGA instead of a GPU. In other words, the control unit may be constituted by a combination of a plurality of FPGAs.

### Effect of the Invention

The present teaching can provide a control unit for an autonomous functioning apparatus capable of suppressing or avoiding complication of a configuration and of performing a much wider variety of work.

### BRIEF DESCRIPTION OF THE DRAWINGS

FIG. 1 is a block diagram showing a configuration of a control unit according to a first embodiment of the present teaching and its peripheral devices.

FIG. 2 is a block diagram showing a configuration of an autonomous functioning system including a control unit according to a second embodiment of the present teaching.

FIG. 3 is a block diagram showing the configuration of the control unit shown in FIG. 2.

FIG. 4 is a flowchart illustrating the cooperative functioning of the control unit shown in FIG. 2.

FIG. 5 is a block diagram illustrating a first application of the control unit shown in FIG. 2.

FIG. 6 is a block diagram illustrating a second application of the control unit shown in FIG. 2.

FIG. 7 is a block diagram illustrating the flow of images in the autonomous functioning system shown in FIG. 2.

FIG. 8 is a flowchart illustrating image control in the functioning control device of the control unit shown in FIG. 7.

FIG. 9 is a block diagram illustrating a third application of the control unit shown in FIG. 2.

FIG. 10 is a block diagram showing a configuration of an autonomous functioning system including a control unit according to a third embodiment of the present teaching.

FIG. 11 is a block diagram showing a configuration of an autonomous functioning system including a control unit according to a fourth embodiment of the present teaching.

### DESCRIPTION OF EMBODIMENTS

Hereinafter, embodiments of the present teaching will be described with reference to the drawings.

### First Embodiment

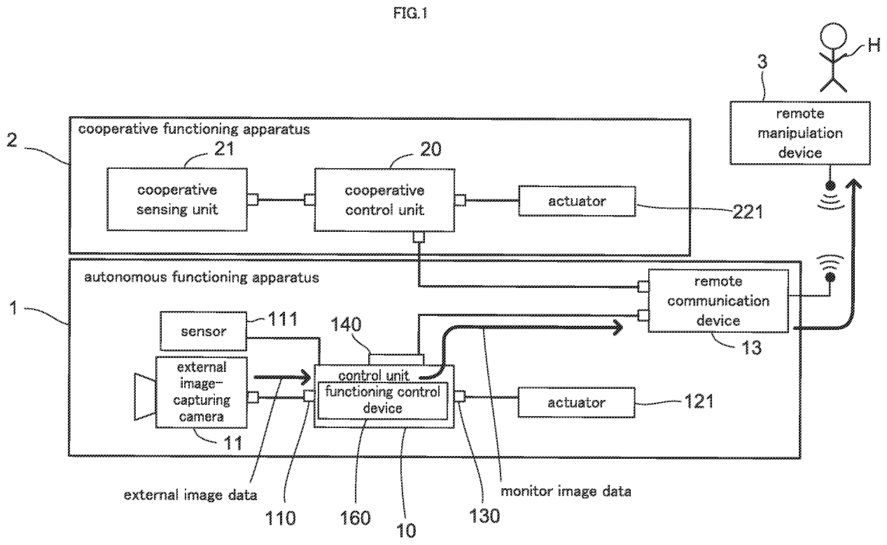

FIG. 1 is a block diagram showing a configuration of a control unit according to a first embodiment of the present teaching and its peripheral devices.

The control unit 10 is employed for the autonomous functioning apparatus 1.

The autonomous functioning apparatus 1 can autonomously function without human operation. The autonomous functioning apparatus 1 is configured to autonomously function on the basis of an external image, that is, an image around the autonomous functioning apparatus 1. However, the autonomous functioning apparatus 1 does not exclude human operation. The autonomous functioning apparatus 1 is configured to be manipulated by the remote manipulation device. The autonomous functioning apparatus 1 can be manipulated by remote operation. For example, a part of the functioning of the autonomous functioning apparatus 1 may be performed by human operation. The autonomous functioning apparatus is, for example, an autonomous vehicle or an autonomous working robot.

The autonomous functioning apparatus 1 is coupled to the cooperative functioning apparatus 2. The cooperative functioning apparatus 2 functions in cooperation with the autonomous functioning apparatus 1. In other words, the autonomous functioning apparatus 1 and the cooperative functioning apparatus 2 cooperate with each other to function so as to complete work expected by an operator H.

The autonomous functioning apparatus 1 comprises a sensor 111, an external image-capturing camera 11, and an actuator 121. The autonomous functioning apparatus 1 is provided with the sensor 111, the external image-capturing camera 11, and the actuator 121. The autonomous functioning apparatus 1 comprises a remote communication device 13. The autonomous functioning apparatus 1 is provided with a remote communication device 13.

The external image-capturing camera 11 captures an external environment of the autonomous functioning apparatus 1. The external image-capturing camera 11 outputs external image data representing an image-capturing result. By using the camera, the autonomous functioning apparatus 1 can function while recognizing a complicated external environment.

The actuator 121 is a device that is mechanically functioned by electric control. The actuator 121 drives a device provided in the autonomous functioning apparatus 1 or the autonomous functioning apparatus 1 itself. The actuator 121 is, for example, a motor or an electromagnetic solenoid.

The control unit 10 comprises an external image connector 110, a functioning control connector 130, an external communication connection part (i.e., external communication connector) 140, and a functioning control device 160.

The external image connector 110 inputs external image data representing an image-capturing result obtained by the external image-capturing camera 11. The external image data is supplied to the functioning control device 160 through the external image connector 110.

The functioning control connector 130 outputs a functioning control signal for controlling functioning of the actuator 121. The functioning control signal is supplied to the functioning control device 160 via the functioning control connector 130.

The external communication connection part 140 is a part where data is inputted from or outputted to one remote communication device 13 communicatively connected to the remote manipulation device 3. The data outputted from the functioning control device 160 is supplied to the remote manipulation device 3 through the external communication connection part 140. On the other hand, the data outputted from the remote manipulation device 3 is supplied to the functioning control device 160 through the external communication connection part 140.

The functioning control device 160 outputs monitor image data from the external communication connection part 140 to the remote manipulation device 3 through the one remote communication device 13 while a cooperative control unit 20 for controlling the cooperative functioning apparatus 2 is connected to the one remote communication device 13.

The monitor image data refers to image data that the functioning control device 160 outputs through the external communication connection part 140. The monitor image data is generated based on the external image data. The monitor image data is, for example, data in which the amount of data is reduced compared to the external image data. The functioning control device 160 performs image compression processing on the external image data to generate monitor image data, thereby reducing the amount of data. An example of image compression processing that does not substantially change the content of an image includes video compression based on the ITU-H.264 standard, compression based on the MPEG standard, or compression based on the JPEG standard. However, the functioning control device 160 may reduce the amount of data by changing the content of the display content image. For example, the functioning control device 160 may reduce the amount of data by reducing the resolution of the image, cropping, or reducing the frame rate.

It is noted that the contents of the monitor image data may be the same as the contents of the external image data, and transmission formats such as the header of the packet may be different from each other.

The functioning control device 160 outputs the monitor image data from the external communication connection part 140 based on the signal outputted from the remote manipulation device 3, the cooperative control unit 20, or the sensor 111.

The functioning control device 160 outputs monitor image data based on external image data representing an image-capturing result obtained by the external image-capturing camera 11 to the remote communication device 13 through the external communication connection part 140. The monitor image data can be transmitted from the remote communication device 13 to the remote manipulation device 3, and then displayed.

The cooperative control unit 20 for the cooperative functioning apparatus 2 is also connected to the remote communication device 13. For example, when the cooperative functioning apparatus 2 has a camera working as a cooperative sensing unit 21 that captures surrounding environments of the cooperative functioning apparatus 2, the cooperative image data outputted from such a camera is also transmitted from the remote communication device 13 to the remote manipulation device 3, and then displayed. More complicated work can be performed based on the images displayed on the remote manipulation device 3. Thus, a much wider variety of work can be performed.

The remote communication device 13 transmits both data based on the external image data from the functioning control device 160 and data based on the cooperative image data from the cooperative functioning apparatus to the remote manipulation device 3. Accordingly, the amount of data transmitted from the cooperative functioning apparatus 2 tends to increase. The functioning control device 160 outputs monitor image data based on external image data inputted through the external image connector 110 to the remote communication device 13 based on the signal outputted from the remote manipulation device 3, the cooperative control unit 20, or the sensor 111. Consequently, image data outputted to the remote manipulation device 3 through the remote communication device 13 can be outputted in response to the signal detected by the remote manipulation device 3, the cooperative control unit 20, or the sensor 111. For example, an image can be adjusted by compressing, superimposing, combining, switching, or cropping, and then outputted to the one remote communication device 13. Consequently, complication of a configuration of the remote manipulation device 3 for receiving the image data from the remote communication device 13 and displaying the image can be suppressed or avoided. This makes preparation and installation of the remote manipulation device 3 easier. Moreover, the aforementioned negative influences by the restriction of communication outputted to the remote manipulation device 3 can be suppressed.

### Second Embodiment

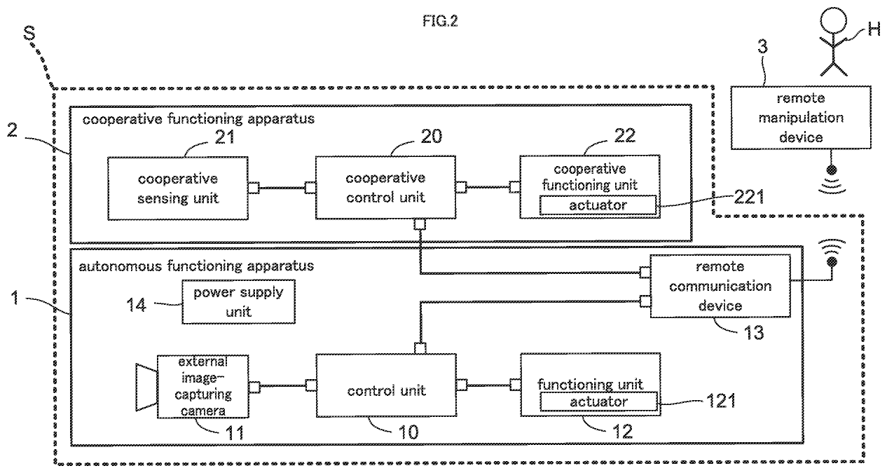

FIG. 2 is a block diagram showing a configuration of an autonomous functioning system including a control unit according to a second embodiment of the present teaching.

In this embodiment, as an application of the control unit 10, the entire autonomous functioning system S including the autonomous functioning apparatus 1 will be described. In this embodiment, an example in which a functional part is added to the autonomous functioning apparatus 1 of the first embodiment will be described. Parts common to those described in the first embodiment will be described with the same reference numerals.

### Autonomous Functioning System

The autonomous functioning system S is a system that can autonomously function without an operator H, that is, human operation. The autonomous functioning system S detects an external environment of the autonomous functioning system S by itself. The autonomous functioning system S recognizes the content of the detected result, and then controls the functioning of the autonomous functioning system S based on the recognized result.

The autonomous functioning system S also works in response to the operation of the operator H. For example, the autonomous functioning system S functions in response to the operation of the remote manipulation device 3. The remote manipulation device 3 is a device for remotely manipulating the autonomous functioning system S. The remote manipulation device 3 can wirelessly communicate with the autonomous functioning system S. The remote manipulation device 3 transmits information of operation to the autonomous functioning system S. In addition, the remote manipulation device 3 receives the image from the autonomous functioning system S and displays the image.

For example, the autonomous functioning system S can start or stop autonomous functioning in response to the operation to start or stop the autonomous functioning on the remote manipulation device 3. In addition, for example, the autonomous functioning system S can select one pattern from a plurality of autonomous functioning patterns in response to the operation to select functioning on the remote manipulation device 3. Furthermore, for example, the autonomous functioning system S can perform sequential functioning in response to sequential operations for the remote manipulation device 3. The sequential operations represented by the operations such as moving forward, moving backward, and stop.

The autonomous functioning system S comprises the autonomous functioning apparatus 1 and the cooperative functioning apparatus 2. The autonomous functioning apparatus 1 shown in FIG. 2 is a system that can autonomously function.

The autonomous functioning apparatus 1 detects an external environment. The autonomous functioning apparatus 1 recognizes the detected result, and then controls functioning based on the recognized result. It is noted that the autonomous functioning apparatus 1 also has a function of functioning in response to the operation of the operator H. The functioning in response to the operation is the same as functioning of the autonomous functioning system S described above.

In the example shown in FIG. 2, the cooperative functioning apparatus 2 is also a system that can autonomously function. The cooperative functioning apparatus 2 detects an external environment. The cooperative functioning apparatus 2 recognizes the detected result, and then controls functioning based on the recognized result. In addition, the cooperative functioning apparatus 2 has a function of functioning in response to the operation of the operator H.

The cooperative functioning apparatus 2 shown in FIG. 2 functions in cooperation with the autonomous functioning apparatus 1. In other words, the autonomous functioning apparatus 1 and the cooperative functioning apparatus 2 cooperate with each other to function so as to complete work expected by the operator H. The cooperative functioning apparatus 2 can cooperate with the autonomous functioning apparatus 1 by, for example, performing same types of functioning as the autonomous functioning apparatus 1. One example of this case is that the autonomous functioning apparatus 1 and the cooperative functioning apparatus 2 are a pair of robot arms.

Further, the cooperative functioning apparatus 2 and the autonomous functioning apparatus 1 can complete the expected functioning, for example, by performing different types of functioning from each other. In other words, the cooperative functioning apparatus 2 and the autonomous functioning apparatus 1 can cooperate with each other. One example of this case is that the autonomous functioning apparatus 1 is an autonomous traveling vehicle and the cooperative functioning apparatus 2 is a robot arm provided in the autonomous traveling vehicle.

The autonomous functioning apparatus 1 and the cooperative functioning apparatus 2 shown in FIG. 2 are mechanically coupled.

However, the autonomous functioning apparatus 1 may be separated from the cooperative functioning apparatus 2. One example of this case is that the autonomous functioning apparatus 1 and the cooperative functioning apparatus 2 are two vehicles traveling in a common area or traveling in a plurality of different adjacent areas.

The cooperative functioning apparatus 2 shown in FIG. 2 is communicatively connected to the autonomous functioning apparatus 1. The autonomous functioning apparatus 1 and the cooperative functioning apparatus 2 shown in FIG. 2 are connected through the remote communication device 13. It is noted that the autonomous functioning apparatus 1 and the cooperative functioning apparatus 2 may be directly and electrically connected to each other by electric wires. In addition, the autonomous functioning apparatus 1 and the cooperative functioning apparatus 2 can be configured, for example, to perform wireless communication.

### The Autonomous Functioning Apparatus

The autonomous functioning apparatus 1 comprises the control unit 10, the external image-capturing camera 11 working also as an external environment sensing unit, a functioning unit 12, the remote communication device 13 and a power supply unit 14.

The external environment sensing unit detects an external environment of the autonomous functioning apparatus 1. In this embodiment, the external environment sensing unit is the external image-capturing camera 11. The external image-capturing camera 11 working as an external environment sensing unit outputs external environment data representing detected results. The external image-capturing camera 11 outputs external environment data representing detected results, wherein the external environment data is the captured images or the images from which the external environment is extracted.

The external image-capturing camera 11 working as an external environment sensing unit outputs external image data representing captured results. By using the camera, the control unit 10 can function the actuator 121 while recognizing complicated external environments.

Hereinafter, the external image-capturing camera 11 working as an external environment sensing unit may be simply referred to as an external environment sensing unit 11.

The functioning unit 12 is controlled based on an external environment. The functioning unit 12 comprises the actuator 121. The actuator 121 is mechanically functioned by electric control, and drives a device provided in the autonomous functioning apparatus 1 or drives the autonomous functioning apparatus 1 itself.

The control unit 10 is connected to the external environment sensing unit 11, the functioning unit 12, and the remote communication device 13.

The control unit 10 controls the actuator 121 of the functioning unit 12 based on the external environment detected by the external environment sensing unit 11. More specifically, the control unit 10 recognizes the content of the external environment by processing external environment data outputted from the external environment sensing unit 11. The control unit 10 determines the control contents based on the recognized contents. The control unit 10 controls the actuator 121 based on the determined control contents.

In some cases, the control unit 10 receives a manipulation command in response to the operation of the remote manipulation device 3 from the remote communication device 13, and controls the actuator 121 based on the manipulation command. The internal configuration of the control unit 10 will be described later.

The power supply unit 14 supplies power to the control unit 10, the external environment sensing unit 11, the functioning unit 12, and the remote communication device 13.

The power supply unit 14 has a battery (not shown). The power supply unit 14 supplies the power stored in the battery to each unit. The power supply unit 14 supplies power in response to the demand of each unit. The power source used by the power supply unit 14 is not limited to a battery, and various power sources can be used. For example, the power supply unit 14 can be configured to have an engine generator or a fuel cell instead of a battery. The engine generator includes, for example, an engine functioned by liquid fuel and a generator driven by the engine to generate electricity.

The power supply unit 14 shown in FIG. 2 also supplies power to the cooperative functioning apparatus 2. However, it is also possible for the cooperative functioning apparatus 2 to have, for example, a power source that is independent from the autonomous functioning apparatus 1.

The remote communication device 13 is communicatively connected to the remote manipulation device 3. The remote communication device 13 is wirelessly communicatively connected to the remote manipulation device 3.

The remote communication device 13 relays communication data between the remote manipulation device 3 and the control unit 10. For example, the remote communication device 13 outputs a manipulation command outputted from the remote manipulation device 3 in response to the operation of the remote manipulation device 3 to the control unit 10. As a result, the manipulation command from the remote manipulation device 3 is supplied to the control unit 10. In addition, for example, the remote communication device 13 supplies data based on the data outputted from the external environment sensing unit 11 to the remote manipulation device 3. For example, when the external environment sensing unit 11 is a camera, the remote communication device 13 transmits data based on external image data outputted from the camera to the remote manipulation device 3. As a result, the image of the camera is displayed on the remote manipulation device 3. In this case, the remote manipulation device 3 transmits an image command to the remote communication device 13. The image command is a command for specifying the content of an image and the amount of image data to be transmitted to the remote manipulation device 3. The remote communication device 13 transmits the image command to the control unit 10.

The above-described data exchange between the remote communication device 13 and the control unit 10 is the same as the data exchange between the remote communication device 13 and the cooperative control unit 20.

### Cooperative Functioning Apparatus

The cooperative functioning apparatus 2 comprises the cooperative control unit 20, the cooperative sensing unit 21, and a cooperative functioning unit 22. The roles of the cooperative control unit 20, the cooperative sensing unit 21, and the cooperative functioning unit 22 in the cooperative functioning apparatus 2 are common to the roles of the control unit 10, the external environment sensing unit 11, and the functioning unit 12 in the autonomous functioning apparatus 1. However, the type of environment detected by the cooperative sensing unit 21, the detailed contents of the determination of the cooperative control unit 20, and the output of the cooperative functioning unit 22 are different depending on the function of the cooperative functioning apparatus 2.

The cooperative control unit 20 controls the cooperative functioning unit 22 that performs physical output. The physical output of the cooperative functioning unit 22 is, for example, the functioning of the actuator 221.

Like the control unit 10, the cooperative control unit 20 corresponds to one example of a control unit according to the present teaching.

One example of the function of the autonomous functioning apparatus 1 shown in FIG. 2 is an autonomous traveling vehicle. In this case, the control unit 10 is, for example, an autonomous navigation unit. The actuator 121 of the functioning unit 12 is a traveling device for traveling the autonomous functioning apparatus 1. The traveling device is, for example, a motor. The control unit 10 recognizes the contents of the image of the traveling area captured by the camera working as the external environment sensing unit 11, determines the traveling route based on the recognized result, and instructs the determined traveling route to the functioning unit 12. In other words, the control unit 10 controls the functioning unit 12 based on the determined traveling route. Consequently, the autonomous functioning apparatus 1 travels autonomously. It is noted that the control unit 10 can be configured to, for example, determine the start or stop of traveling on a predetermined traveling route without determining the route itself.

One example of the function of the cooperative functioning apparatus 2 shown in FIG. 2 is a working apparatus provided in an autonomous traveling vehicle. One example of the working apparatus is a fruit thinning device for thinning fruit on a farm. In this case, the cooperative control unit 20 recognizes the content of the fruit tree captured by the camera working as the cooperative sensing unit 21, determines the state and position of the fruit based on the recognized result, and transmits a traveling command (traveling position command) to the autonomous functioning apparatus 1 based on the determined position of the fruit. The traveling command is one example of the functioning command. The actuator 221 of the fruit thinning device working as the cooperative functioning unit 22 is controlled based on the determined position of the fruit. The autonomous functioning apparatus 1 and the cooperative functioning apparatus 2 cooperate with each other to allow for a function of thinning fruit in a farm.

The cooperative functioning apparatus 2 provided in the autonomous functioning apparatus 1 can be replaced with a cooperative functioning apparatus having a function different from the cooperative functioning apparatus 2 shown in FIG. 2.

### Control Unit

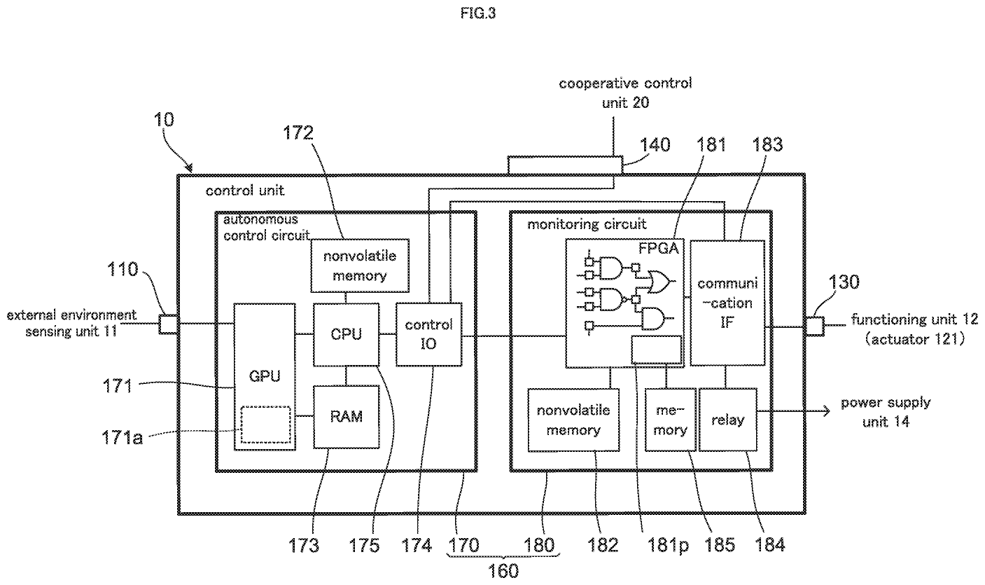

FIG. 3 is a block diagram showing the configuration of the control unit 10 shown in FIG. 2.

The control unit 10 is a unit covered with one housing and is incorporated in the autonomous functioning apparatus 1 (See FIG. 2). The control unit 10 is electrically connected to each part of the autonomous functioning apparatus 1.

The control unit 10 is a commercial unit. The control unit 10 is a mass production type.

The control unit 10 comprises an external environment information connector 110, the functioning control connector 130, the external communication connection part 140, and the functioning control device 160.

The external environment information connector 110 is electrically connected to the external environment sensing unit 11 shown in FIG. 2. External environment data representing a result of detection is inputted from the external environment sensing unit 11 to the control unit 10 through the external environment information connector 110.

When the external environment sensing unit 11 is, for example, a camera, the external environment information connector 110 works as the external image connector. Hereinafter, the external environment information connector 110 is also referred to as the external image connector 110.

The functioning control connector 130 is electrically connected to the functioning unit 12 shown in FIG. 2. A functioning control signal for controlling functioning of the actuator 121 is outputted from the control unit 10 to the functioning unit 12 through the functioning control connector 130.

The external communication connection part 140 is electrically connected to the remote communication device 13 shown in FIG. 2. The remote communication device 13 is connected to the cooperative control unit 20. The remote communication device 13 in this embodiment works as a hub. In other words, the remote communication device 13 outputs a signal outputted from the external communication connection part 140 to the cooperative control unit 20, and outputs a signal outputted from the cooperative control unit 20 to the external communication connection part 140. Accordingly, the external communication connection part 140 is communicably connected to the cooperative control unit 20 shown in FIG. 2. The external communication connection part 140 in the example shown in FIG. 2 is an external communication connector electrically connected to the remote communication device 13. As described above, the remote communication device 13 works as a hub. In other words, from the viewpoint of the external communication connection part 140, the cooperative control unit 20 can be identified with the remote communication device 13. Thus, the external communication connection part 140 can be referred to as an external communication connector electrically connected to the cooperative control unit 20. Hereinafter, the external communication connection part 140 is also referred to as the external communication connector 140. The external communication connector 140 physically includes a plurality of connectors corresponding to a plurality of types of transmission forms. The types of transmission forms are, for example, a controller Area Network (CAN) (registered trade mark) and an Ethernet (registered trade mark). By having a plurality of connectors, the cooperative control unit 20 can be selected from a plurality of possible units having various functions. The versatility of the control unit 10 is improved. The external communication connector 140 is one example of the external communication connection part communicatively connected to the cooperative control unit 20. The external communication connection part can be configured, for example, to use a wireless communication apparatus instead of the external communication connector 140.

The external communication connection part 140 is electrically connected to the remote communication device 13 shown in FIG. 2. A signal representing manipulation command is inputted from the remote manipulation device 3 (See FIG. 2) and the remote communication device 13 to the control unit 10 through the external communication connection part 140. In other words, in response to a request for transmitting an image inputted from the remote manipulation device 3 to the remote communication device 13, a signal representing manipulation command is outputted from the remote communication device 13 and inputted to the control unit 10 through the external communication connection part 140. In addition, a signal representing an external environment or a state of the control unit 10 is outputted to the remote communication device 13 from the control unit 10 through the external communication connection part 140. This signal is supplied to the remote manipulation device 3 from the remote communication device 13.

The functioning control device 160 controls the actuator 121 of the functioning unit 12 based on the external environment detected by the external environment sensing unit 11 shown in FIG. 2. More specifically, the functioning control device 160 processes external environment data outputted from the external environment sensing unit 11. The functioning control device 160 controls the actuator 121 based on processing results of external environment data. The functioning control device 160 receives a manipulation command in response to the operation of the remote manipulation device 3 from the remote communication device 13, and controls the functioning unit 12 based on the manipulation command.

Moreover, the functioning control device 160 communicates with the cooperative control unit 20 connected through the external communication connector 140. As described above, the cooperative functioning apparatus 2 can be selected from various apparatuses that can be combined with the autonomous functioning apparatus 1.

In a situation, the cooperative functioning apparatus 2 transmits a functioning command to the functioning control device 160. The cooperative functioning apparatus 2 is a cooperative control unit 20 configured to receive a functioning command from the functioning control device 160 in a situation different from the one described above.

The functioning control device 160 switches the type of functioning depending on the situation of the cooperative control unit 20.

When the functioning control device 160 receives a functioning command from the cooperative control unit 20, the functioning control device 160 generates a functioning control signal based on the functioning command. The functioning control device 160 outputs the generated functioning control signal to the actuator 121 of the functioning unit 12 through the functioning control connector 130.

On the other hand, when the functioning control device 160 does not receive a functioning command from the cooperative control unit 20, the functioning control device 160 generates a functioning command for controlling the cooperative functioning apparatus 2 based on processing results of external environment data inputted from the external environment sensing unit 11. The functioning control device 160 transmits the generated functioning command to the cooperative control unit 20 through the external communication connector 140.

Thus, even when any of an apparatus in which the input/output of a functioning command changes depending on a situation and an apparatus in which the input/output is fixed are connected to the external communication connector 140 of the control unit 10 as the cooperative control unit 20, precise work can be performed in cooperation with the cooperative control unit 20. Consequently, the versatility of the control unit 10 can be improved.

### Configuration of the Functioning Control Device

As shown in FIG. 3, the functioning control device 160 comprises an autonomous control circuit 170 and a monitoring circuit 180.

The autonomous control circuit 170 and the monitoring circuit 180 are provided in the housing of the control unit 10.

The autonomous control circuit 170 performs basic control processing in the functioning control device 160. More specifically, the autonomous control circuit 170 controls the actuator 121 based on an external environment signal from the external environment sensing unit 11. More specifically, the autonomous control circuit 170 executes a software process to output a functioning control signal based on an external environment signal. The autonomous control circuit 170 also outputs a status indicator signal by executing a software process.

The autonomous control circuit 170 comprises a Graphics Processing Unit (GPU) 171.

The GPU 171 is a processor having a multi-core capable of parallel processing. The GPU 171 comprises one hundred or more operation cores functionable in parallel. The GPU 171 performs SIMD (single-instruction multiple-data stream) operations by one hundred or more operation cores.

The autonomous control circuit 170 comprises a nonvolatile memory 172, a RAM 173, a control input/output (Control TO) 174, and a CPU 175. The nonvolatile memory 172 is, for example, a mask ROM flash memory or an EEPROM.

The CPU 175 is a central processing unit. The CPU 175 controls the entire autonomous control circuit 170. The GPU 171 and the CPU 175 share control of the autonomous control circuit 170. More specifically, the CPU 175 causes the GPU 171 to perform some of the functions of the autonomous control circuit 170. The functions performed by the GPU 171 will be described later.

The nonvolatile memory 172 stores programs to be executed by the CPU 175 and the GPU 171. The CPU 175 sequentially reads and executes programs stored in the nonvolatile memory 172. Thus, control by the autonomous control circuit 170 is performed.

The program of the GPU 171 stored in the nonvolatile memory 172 is read by the CPU 175 and supplied to the GPU 171.

The RAM 173 holds the result of processing in the CPU 175 and the result of processing in the GPU 171. The CPU 175 and the GPU 171 read data from the RAM 173 and write data to the RAM 173. The RAM 173 stores data inputted to the CPU 175 and the GPU 171, data representing the state of processing, and data representing a functioning control signal outputted from the autonomous control circuit 170 as a result of processing. The data inputted to the GPU 171 is, for example, data representing an external environment signal. The data representing the processing status is, for example, one of the parameters representing the operation status of the autonomous control circuit 170.

The control IO 174 relays signals inputted to and outputted from the CPU 175 and the GPU 171. The CPU 175 and the GPU 171 output a status indicator signal representing the operation status of the control model through the control IO 174. The status indicator signal is, for example, a pulse representing the period and time at which the process of processing the control model is executed. The status indicator signal is one of the parameters representing the functioning status of the autonomous control circuit 170. The contents stored in the RAM 173 can be read into an FPGA 181 of the monitoring circuit 180 through the control IO 174.

The CPU 175 supplies the program stored in the nonvolatile memory 172 to the GPU 171. The CPU 175 outputs a command to execute the program to the GPU 171.

The GPU 171 executes a program stored in the nonvolatile memory 172, and thus, a control model 171a constructed by machine learning is constituted in the autonomous control circuit 170. The control model 171a is a model showing the relationship between the external environment detected by the external environment sensing unit 11 and the control of the functioning unit 12 to be controlled. The control model 171a is a machine learning model using a neural network.

Since the GPU 171 can perform SIMD operations on one hundred or more operation cores, processing of the control model 171a with large scale matrix repetition operations can be performed at high speed.

The CPU 175 determines the functioning of the control unit 10 based on the information of the object obtained as a result of applying the data of the external environment to the machine learning model. The CPU 175 controls the functioning unit 12 based on the result of the determination. More specifically, the CPU 175 outputs a command to the functioning control connector 130 through, for example, the control IO 174 and a communication IF 183 of the monitoring circuit 180.

The CPU 175 transmits a command to the cooperative control unit 20 based on the result of the determination. The CPU 175 transmits data to the remote communication device 13.

It is noted that the sharing of control between the CPU 175 and the GPU 171 and the input/output of the model executed by the GPU 171 are not limited to those described above. For example, the machine learning model may be, for example, a model that directly shows the relationship between external image data and the optimal traveling route or the functioning path of an arm or the like. In this case, the CPU 175 controls the functioning unit 12 based on the traveling route or the functioning path outputted as the processing result of the GPU 171.

The monitoring circuit 180 constitutes the control unit 10 integrally with the autonomous control circuit 170.

The monitoring circuit 180 comprises a field programmable gate array (FPGA) 181 and a nonvolatile memory 182. The monitoring circuit 180 comprises a communication interface (communication IF) 183, a relay 184, and a memory 185 for programing.

The FPGA 181 has a reprogrammable logic circuit. The nonvolatile memory 182 stores connection information of a logic circuit for monitoring constructed by the FPGA 181. The FPGA 181 reads the connection information from the nonvolatile memory 182 in initialization processing after power-on or reset. The FPGA 181 constructs a logic circuit based on the connection information. After constructing a logic circuit, the FPGA 181 starts processing by the logic circuit.

By changing the data stored in the nonvolatile memory 182, the function constructed by the logic circuit can be changed. Accordingly, in the monitoring circuit 180, the conditions of monitoring can be changed by changing the connection information, which is the software stored in the nonvolatile memory 182, and the hardware based on the connection information.

The FPGA 181 may have a fixed logic circuit other than a reprogrammable logic circuit. For example, the FPGA 181 includes a processor 181p as a logic circuit and a memory. The processor 181p executes, for example, processing while sequentially reading programs stored in the memory 185. This allows for more advanced processing. The memory 185 read by the processor 181p is nonvolatile. However, unlike the nonvolatile memory 182 for the FPGA 181, the memory 185 stores not connection information but programs that are sequentially read out to the processor. By dividing the memory corresponding to the application, the reliability of the logic circuit constituted of the FPGA 181 is improved.

The communication IF 183 is an interface for the FPGA 181 and the autonomous control circuit 170 to communicate with the functioning unit 12. The communication IF 183 provides, for example, a physical interface for communicating with the functioning unit 12. The physical interface is, for example, CAN. The autonomous control circuit 170 outputs a functioning control signal through the communication IF 183.

The relay 184 interrupts the power supply of the power supply unit 14 (See FIG. 2) to the functioning unit 12. More specifically, the relay 184 is energized by control of the FPGA 181 to transmit a supply signal for causing the power supply unit 14 to supply power. When energization of the relay 184 is stopped by control of the FPGA 181, transmission of the supply signal is stopped. As a result, the power supply from the power supply unit 14 is interrupted. The interruption of power supply can surely stop functioning.

The supply signal from the relay 184 can pass through other relays (not shown) provided outside the monitoring circuit 180 as well as provided in each part of the autonomous functioning apparatus 1 and the cooperative functioning apparatus 2. As a result, the power supply is immediately interrupted by a part of interrupted control. Thus, functioning can be surely stopped.

In a logic circuit constituted of the FPGA 181 of the monitoring circuit 180, an abnormality of functioning of the autonomous control circuit 170 is detected by a rule-based logic.

For example, when the monitoring circuit 180 detects an abnormality, the monitoring circuit 180 controls so as to force the autonomous control circuit 170 to display an image of a camera on the remote manipulation device 3. This allows an operator to perform the corresponding manipulation immediately

The output from the monitoring circuit 180 is not limited to the above-described combination. For example, the monitoring circuit 180 can be configured to inhibit the output of a functioning control signal by the autonomous control circuit 170 instead of outputting a functioning command when the monitoring circuit 180 detects an abnormality of at least one parameter associated with at least one type of signal. In this case, the monitoring circuit 180 stops the functioning of the communication IF 183 that outputs the signal from the autonomous control circuit 170. This suppresses a situation in which an abnormal functioning control signal is continuously outputted.

The basic hardware structure of the control unit 10 described above is also applied to the cooperative control unit 20. However, when the output content based on the detection result of the abnormality of the cooperative sensing unit 21 is different from the output content in the control unit 10, a part of the hardware and the software are different from those of the control unit 10 corresponding to the difference.

### Cooperative Functioning with the Cooperative Control Unit

The control unit 10 comprising above functions in cooperation with the cooperative control unit 20.

The control unit 10 functions in cooperation with the cooperative control unit 20 even when any of an apparatus in which the input/output of a functioning command changes depending on a situation and an apparatus in which the input/output is fixed are connected as a cooperative control unit 20.

Next, the details of the cooperative functioning with the cooperative control unit 20 will be described.

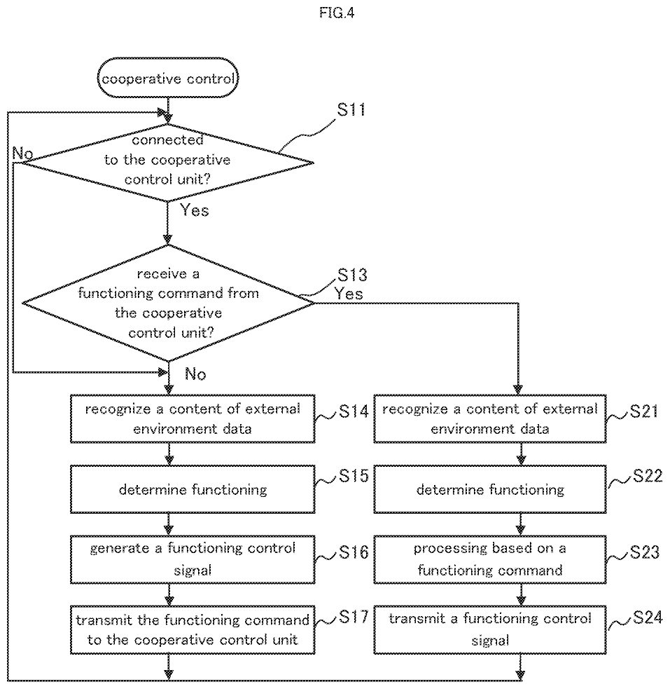

FIG. 4 is a flowchart for describing cooperative functioning among functioning of the control unit shown in FIG. 2.

Determination of the type of the cooperative control unit 20 and the cooperative functioning according to the type are performed by the functioning control device 160.

The determination of the type and the cooperative functions according to the type are mainly performed by the autonomous control circuit 170 shown in FIG. 3. However, for example, the processor 181p provided in the monitoring circuit 180 can be configured to perform the determination of the type of the cooperative control unit 20. The remote manipulation device 3 can be configured to instruct the determination of the type and the cooperative functioning according to the type.

Here, cooperative functioning will be described as functioning of the functioning control device 160.

First, in the cooperative functioning, the functioning control device 160 determines whether or not the cooperative control unit 20 is connected (S11). For example, the functioning control device 160 determines whether or not communication with the cooperative control unit 20 is possible through the external communication connection part 140.

When the cooperative control unit 20 is connected, the cooperative control unit 20 can communicate with the functioning control device 160 of the control unit 10. In this case, the functioning control device 160 determines that the cooperative control unit 20 is connected.

Next, the functioning control device 160 determines whether or not a functioning command is received from the cooperative control unit 20 (S13).

When the functioning command is not received from the cooperative functioning apparatus 2 (No at S13), the functioning control device 160 recognizes the content of the external environment data by processing the external environment data (S14).

More specifically, for example, when the autonomous functioning apparatus 1 is an autonomous traveling vehicle, the functioning control device 160 performs processing for recognizing the content of the image data representing the external image based on the constructed control model.

The functioning control device 160 determines the functioning based on the recognized result of the content of the external environment data (S15).

More specifically, for example, the functioning control device 160 ascertains the present position of the autonomous functioning apparatus 1 and determines the optimum traveling route based on the recognition of the contents of the image data.

The functioning control device 160 generates a functioning control signal based on the processing result of the external environment data (S16). The functioning control device 160 outputs the generated functioning control signal to the actuator 121 of the functioning unit 12 through the functioning control connector 130.

More specifically, for example, the functioning control device 160 generates a functioning control signal comprising commands of traveling and steering based on the determined traveling route, and outputs the generated functioning control signal to the functioning unit 12. The functioning unit 12 functions the actuator 121. Accordingly, the autonomous functioning apparatus 1 functions based on the external environment.

The functioning control device 160 transmits a functioning command for controlling the cooperative functioning apparatus 2 based on the processing result of the external environment data (S17).

More specifically, for example, the functioning control device 160 generates a functioning command for the cooperative control unit 20 to function depending on the position of the autonomous functioning apparatus 1 on the traveling route. The functioning control device 160 transmits the functioning command to the cooperative control unit 20 through the external communication connection part 140.

When the functioning command is received from the cooperative functioning apparatus 2 (Yes at S13), the functioning control device 160 recognizes the content of the external environment data by processing the external environment data (S21). The functioning control device 160 determines the functioning based on the recognized result of the content of the external environment data (S22). Functioning at these steps is the same as functioning at steps S14 and S15 described above.

Next, the functioning control device 160 performs processing based on a functioning command from the cooperative control unit 20 (S23). The cooperative control unit 20 transmits the functioning command to the control unit 10 through the external communication connection part 140. The functioning control device 160 performs processing based on the functioning command.

More specifically, for example, the cooperative control unit 20 transmits a functioning command representing whether the autonomous functioning apparatus 1 moves forward or backward depending on the position of the work object to the functioning control device 160 of the control unit 10.

Next, the functioning control device 160 transmits a functioning control signal for controlling the cooperative functioning apparatus 2 based on the functioning command received through the external communication connection part 140 (S24). The functioning control device 160 generates a functioning control signal based on the external environment data recognized at step 21 and the functioning command.

More specifically, for example, the functioning control device 160 generates and outputs a functioning control signal to the functioning unit 12 to move forward or move backward along the determined traveling route. The functioning unit 12 functions the actuator 121. Accordingly, the autonomous functioning apparatus 1 functions based on the functioning command of the cooperative control unit 20.

A process for outputting a functioning control signal to the actuator 121 based on a functioning command received from the cooperative control unit 20 and conversely a process for transmitting the functioning command to the cooperative control unit 20 through the external communication connection part 140 can be sequentially performed.

### First Application of the Cooperation

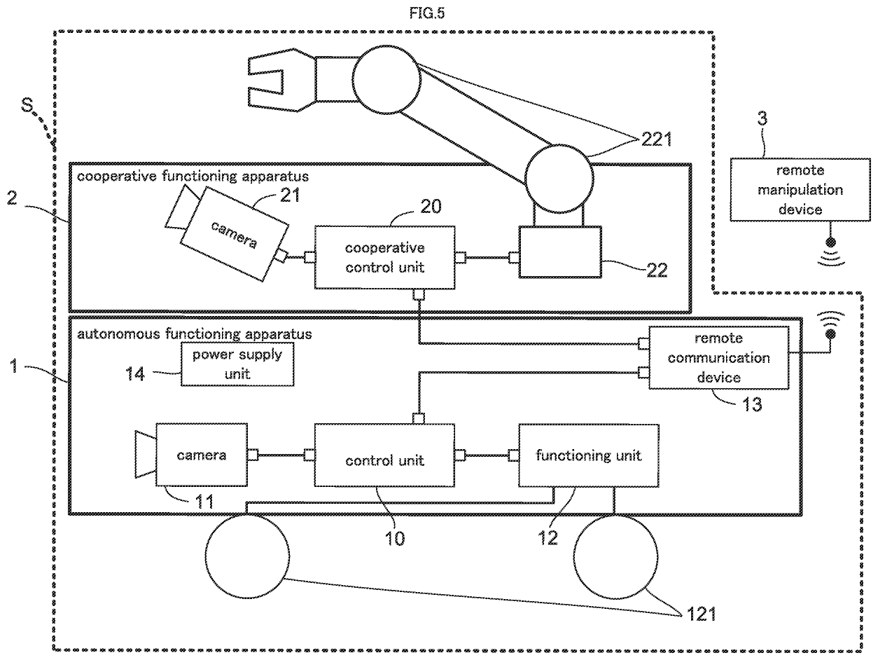

FIG. 5 is a block diagram showing a first application of the control unit shown in FIG. 2.

The application in FIG. 5 shows a case where the autonomous functioning apparatus 1 is an autonomous traveling vehicle and the cooperative control unit 20 outputs functioning commands at a high frequency. The cooperative functioning apparatus 2 is an autonomous functioning robot provided in the autonomous traveling vehicle.

For example, the cooperative control unit 20 recognizes the position of the work object to the robot based on the image of the cooperative functioning apparatus camera (a camera for a robot) 21 working as the cooperative sensing unit. The cooperative control unit 20 transmits a functioning command including forward/backward movement to the functioning control device 160 of the control unit 10 depending on the position of the work object. The functioning control device 160 generates a functioning control signal based on the functioning command received from the cooperative control unit 20. The functioning control device 160 outputs the generated functioning control signal to the actuator 121 of the functioning unit 12 through the functioning control connector 130. The autonomous functioning apparatus 1 and the cooperative functioning apparatus 2 can cooperate with each other to perform precise work.

### Second Application of the Cooperation

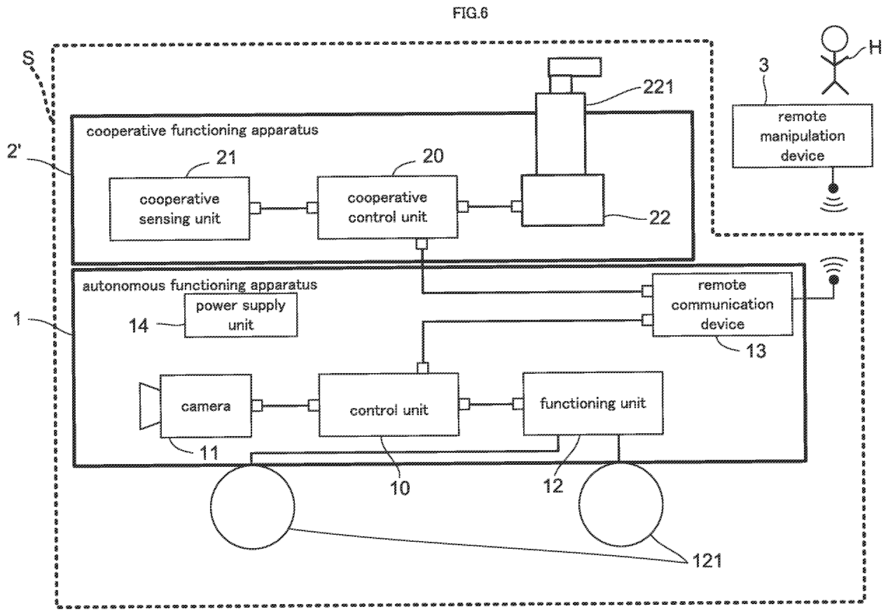

FIG. 6 is a block diagram showing a second application of the control unit shown in FIG. 2.

The application in FIG. 6 shows a case where the autonomous functioning apparatus 1 is an autonomous traveling vehicle, and the cooperative control unit 20 outputs functioning commands at a low frequency or does not output functioning commands. The cooperative functioning apparatus 2′ is a simple working apparatus provided in the autonomous functioning apparatus 1. The cooperative functioning apparatus 2′ is, for example, a sprayer for spraying a chemical agent or the like toward a work object. The cooperative sensing unit 21 detects, for example, the remaining amount of the liquid to be sprayed.

The functioning control device 160 generates a functioning command for controlling the cooperative functioning apparatus 2′ based on the processing result of image data from the external image-capturing camera working as the external environment sensing unit 11. The functioning control device 160, for example, generates a functioning command for causing the cooperative functioning apparatus 2′ to start or stop the work functioning based on the position of the autonomous traveling vehicle obtained as a result of processing the image data of the external image-capturing camera, and transmits the functioning command to the cooperative control unit 20.

Accordingly, the cooperative functioning apparatus 2′ can appropriately function in response to the traveling of the autonomous traveling vehicle as the autonomous functioning apparatus 1.

As described with reference to the examples of FIG. 5 and FIG. 6, the control unit 10 can perform precise work in cooperation with the cooperative control unit 20 even when any of an apparatus in which input/output of a functioning command changes depending on a situation and an apparatus in which the input/output is fixed are connected to the external communication connector 140 of the control unit 10. Consequently, the versatility of the control unit 10 can be improved.

### Image Transmission in Remote Manipulation

For example, when work is difficult to be performed only by autonomous functioning due to an obstacle on a traveling route, or when functioning is tested or confirmed, the autonomous functioning system S functions in response to the operation of the remote manipulation device 3 by an operator H.

In this case, the autonomous functioning system S functions in response to the operation of the remote manipulation device 3 by the operator H. The remote manipulation device 3 displays an image based on image data of the external image-capturing camera 11 and/or an image based on image data of the cooperative functioning apparatus camera 21.

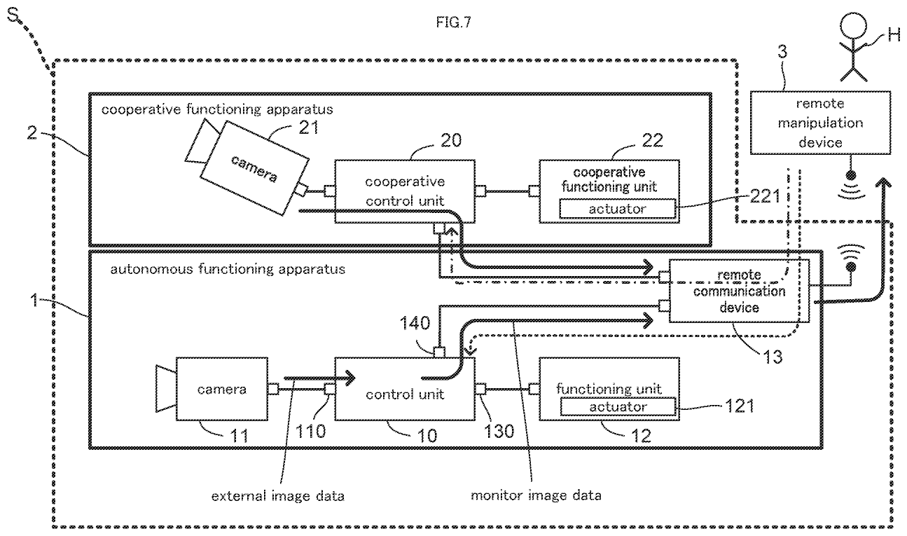

FIG. 7 is a block diagram showing a flow of an image in the autonomous functioning system shown in FIG. 2.

The solid arrow in FIG. 7 shows the flow of an image when the autonomous functioning system S is remotely manipulated. The dashed arrow in FIG. 7 shows the flow of an image request signal from the remote manipulation device 3. FIG. 7 shows the external image-capturing camera as one example of the external environment sensing unit 11. FIG. 7 also shows the cooperative functioning apparatus camera as the cooperative sensing unit 21. Hereinafter, the external environment sensing unit 11 is also referred to as the external image-capturing camera 11. In addition, the cooperative sensing unit 21 is also referred to as the cooperative functioning apparatus camera 21.

It is also possible to adopt a configuration in which the flow of the image request signal from the remote manipulation device 3 is directed toward the cooperative control unit 20 as shown by a chain line in FIG. 7. In such a configuration, for example, at a certain timing, a configuration can be adopted in which either one of a flow of an image request signal toward the cooperative control unit 20 (chain line) and a flow of an image request signal toward the control unit 10 (dashed line) is enabled. This allows, for example, for switching between the image of the external image-capturing camera 11 and the image of the cooperative functioning apparatus camera 21 in the remote manipulation device 3.

In addition to the configuration described above in which either one of flows is enabled, a configuration also can be adopted in which both a flow of an image request signal toward the cooperative control unit 20 (chain line) and a flow of an image request signal toward the control unit 10 (dashed line) is enabled at a certain timing. For example, an image of the external image-capturing camera 11 and an image of the cooperative functioning apparatus camera 21 are simultaneously displayed on the remote manipulation device 3.

Further, in the configuration described above in which both of flows are enabled, for example, a configuration can be adopted in which the contents of image commands for the cooperative control unit 20 and the control unit 10 are adjusted depending on the state of wireless communication between the remote communication device 13 and the remote manipulation device 3.

The autonomous functioning apparatus 1 is provided with the external image-capturing camera 11 for capturing an external environment and the actuator 121. The cooperative functioning apparatus 2 comprises the cooperative functioning apparatus camera 21 for capturing an external environment.

The control unit 10 of the autonomous functioning apparatus 1 is connected to the one remote communication device 13.

The control unit 10 of the autonomous functioning apparatus 1 and the cooperative control unit 20 of the cooperative functioning apparatus 2 are connected to the one remote communication device 13. In other words, both the control unit 10 and the cooperative control unit 20 use the one remote communication device 13.

The functioning control device 160 of the control unit 10 (See FIG. 3) also performs image control including obtainment of an image command signal.

As described above, the control unit 10 comprises the external image connector 110, the functioning control connector 130, and the functioning control device 160 (See FIG. 3).

The external image connector 110 (the external environment information connector 110) is a connector for inputting external image data representing captured results from the external image-capturing camera 11 to the control unit 10.

The functioning control connector 130 is a connector through which the control unit 10 outputs a functioning control signal for controlling the operation of the actuator 121.

The external communication connection part 140 works, where data is inputted to or outputted from the one remote communication device 13 communicatively connected to the remote manipulation device 3. The external communication connection part 140 also works as a connector in which data is inputted to or outputted from the cooperative control unit 20.

The functioning control device 160 of the control unit 10 (See FIG. 3) outputs monitor image data based on the external image data inputted through the external image connector 110 from the external communication connection part 140 to the remote manipulation device 3 through the one remote communication device 13. The functioning control device 160 outputs monitor image data based on an image command signal from the outside of the control unit 10.

The cooperative control unit 20 processes image data from the cooperative functioning apparatus camera 21 in the same way as the control unit 10. The operation in the functioning control device 160 of the control unit 10 will be described as a representative example.

### Control of Image Flow

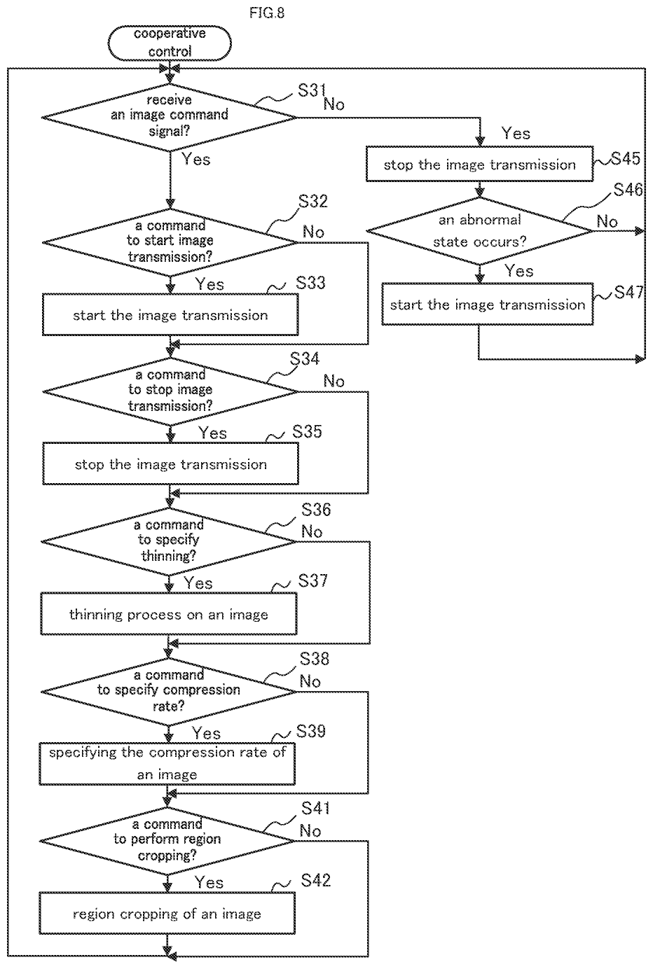

FIG. 8 is a flowchart for describing image control in the functioning control device 160 of the control unit 10 shown in FIG. 7.

The functioning control device 160 determines whether or not an image command signal has been received from the outside (S31). The image command signal is transmitted from the remote communication device 13 through the external communication connection part 140. It is noted that the image command signal may be transmitted from the cooperative control unit 20 through the external communication connector 140. The functioning control device 160 determines the image command signals to be transmitted through both connectors.

When the image command signal is received (Yes at S31), the functioning control device 160 determines whether the content of the image command signal represents the start of image transmission (S32).

In case of the start of image transmission (Yes at S32), the functioning control device 160 transmits monitor image data to the remote manipulation device 3 (S33). In other words, the functioning control device 160 outputs the monitor image data to the remote manipulation device 3. The monitor image data is data obtained by processing external image data inputted through the external image connector 110. The functioning control device 160 generates monitor image data having a smaller data amount than external image data by performing image compression processing on the external image data. However, external image data which is not substantially processed may be used as the monitor image data. The functioning control device 160 outputs monitor image data from the external communication connection part 140 to the one remote communication device 13. The monitor image data is transmitted to the remote manipulation device 3 through the remote communication device 13.

The functioning control device 160 determines whether the content of the image command signal represents the stop of image transmission (S34).

In case of the stop of image transmission (Yes at S34), the functioning control device 160 stops transmission of monitor image data (S35). In other words, the functioning control device 160 stops outputting the monitor image data. As a result, transmission of the monitor image data to the remote manipulation device 3 is stopped.

The image command signal representing the stop of image transmission may be outputted from the cooperative control unit 20. One example of this case is that the cooperative control unit 20 transmits the image command signal representing the stop of image transmission to the control unit 10 when the cooperative control unit 20 receives a command to transmit only an image of the cooperative functioning apparatus camera 21 from the remote manipulation device 3. By stopping the transmission of data based on the image data of the external image-capturing camera 11, an image to which the operator H wants to pay attention during manipulation can be displayed on the remote manipulation device 3 while the amount of data to be transmitted is reduced.

The functioning control device 160 determines whether the content of the image command signal represents frame thinning (S36).

In case of frame thinning (Yes at S36), the functioning control device 160 performs frame thinning processing to the monitor image data (S37). This reduces the data amount of the monitor image data to be transmitted to the remote manipulation device 3.

The functioning control device 160 determines whether the content of the image command signal represents the image compression rate (S38). In case of the image compression rate (Yes at S38), the functioning control device 160 specifies the compression rate of the image compression processing (S39). This reduces the amount of the monitor image data to be transmitted to the remote manipulation device 3.

The functioning control device 160 determines whether the content of the image command signal represents the crop of a part of the region of an image (S41).

In case of the region cropping (Yes at S41), the functioning control device 160 performs region cropping processing on the monitor image data (S42). In other words, the functioning control device 160 extracts a part of the region of an image specified by the image command from images captured by the external image-capturing camera 11, and then generates monitor image data. More specifically, for example, when a broad range is captured by the external image-capturing camera 11, only a part of the region of the image in the traveling direction that is necessary for manipulation is transmitted and displayed. This reduces the amount of the monitor image data to be transmitted to the remote manipulation device 3.

It is noted that the crop of a part of the region of an image is also performed when, for example, a plurality of the external image-capturing cameras 11 is connected to the control unit 10, and the functioning control device 160 processes images representing a plurality of regions captured by the plurality of the external image-capturing cameras 11. In case of the region cropping (Yes at S41), the functioning control device 160 sets only the specified region of the image as monitor image data. This also reduces the amount of the monitor image data to be transmitted to the remote manipulation device 3.

If it is determined at the Step 31 described above that the image command signal is not received (No at S31), the functioning control device 160 stops the transmission of the monitor image data (S45). In other words, the functioning control device 160 stops outputting the monitor image data.

Next, the functioning control device 160 determines whether the control unit 10 is in an abnormal state (S46). The abnormal state of the control unit 10 is detected, for example, by a logic circuit constituted by the FPGA 181 in the monitoring circuit 180.

For example, the functioning control device 160 determines that the control unit 10 is in an abnormal state if any of the parameters to be monitored is not within the range determined by a rule.

In case of being in the abnormal state (Yes at S46), the functioning control device 160 transmits monitor image data to the remote manipulation device 3 (S47). In other words, the functioning control device 160 outputs monitor image data to the remote manipulation device 3. The monitor image data is transmitted to the remote manipulation device 3 through the remote communication device 13.

This allows an operator H to recognize the occurrence of the abnormal state at an early stage by watching the display screen of the remote manipulation device 3. This also allows an operator H to recognize the cause of the abnormal state at an early stage by watching the display screen.

### Examples of Separate Functioning of the Cooperative Functioning Apparatus

Heretofore, embodiments where the cooperative functioning apparatus 2 is coupled to the autonomous functioning apparatus 1 have been described. However, the control unit 10 of the present embodiment can be configured to correspond to a cooperative functioning apparatus 4 that functions separately without being coupled to the autonomous functioning apparatus 1.

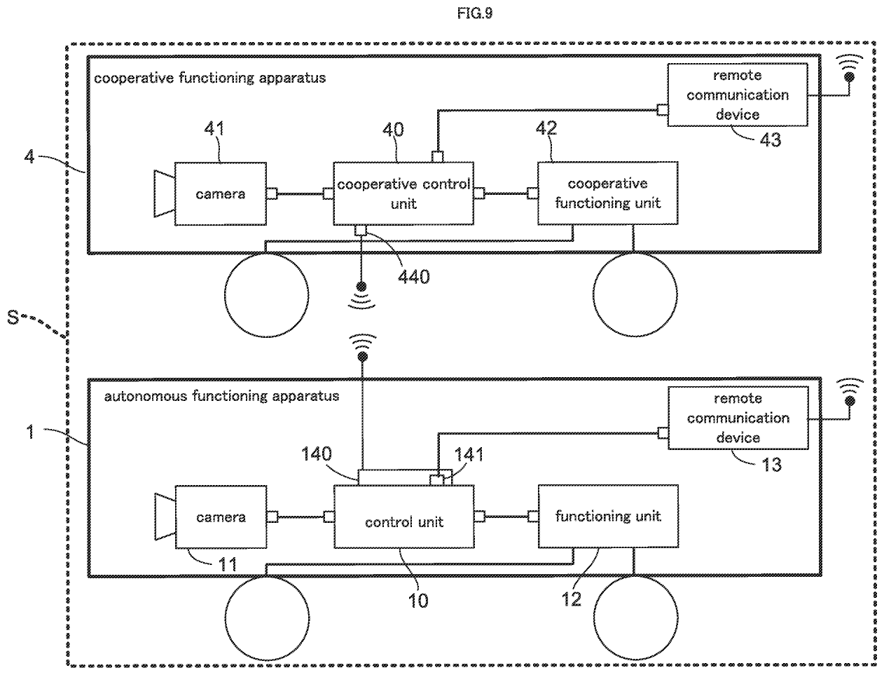

FIG. 9 is a block diagram showing a third application of the control unit shown in FIG. 2.

In the application shown in FIG. 9, the cooperative functioning apparatus 4 of the autonomous functioning system S is not coupled to the autonomous functioning apparatus 1. The cooperative functioning apparatus 4 functions away from the autonomous functioning apparatus 1. The cooperative functioning apparatus 4 is, for example, an autonomous traveling vehicle having substantially the same configuration as the autonomous functioning apparatus 1.

The external communication connection part 140 provided in the control unit 10 of the autonomous functioning apparatus 1 includes the external communication connector 141 and a wireless communication part. The cooperative functioning apparatus 4 comprises an external communication connection part 440 for performing wireless communication with the external communication connection part 140. The control unit 10 of the autonomous functioning apparatus 1 communicates with the cooperative control unit 40 of the cooperative functioning apparatus 4 through wireless communication. The cooperative control unit 40 controls the cooperative functioning unit 42.

The control unit 10 of the autonomous functioning apparatus 1 outputs a functioning control signal based on a functioning command from the cooperative control unit 40. For example, the control unit 10 travels in response to the functioning command from the cooperative control unit 40. In this case, for example, the control unit 10 determines start or stop of traveling of the autonomous functioning apparatus 1 in response to a functioning command received from the cooperative control unit 40 of the cooperative functioning apparatus 4 while the external image-capturing camera 11 captures an external environment of the autonomous functioning apparatus 1 and the control unit 10 determines the traveling route by itself based on the image data obtained by the external image-capturing camera 11. In this way, the autonomous functioning apparatus 1 can also travel in cooperation with the cooperative functioning apparatus 4.

The control unit 10 generates a functioning command for controlling the cooperative functioning apparatus 4 based on image data obtained by the external image-capturing camera 11. The control unit 10 transmits the functioning command to the cooperative control unit 40. The cooperative functioning apparatus 4, for example, determines start or stop of traveling of the cooperative functioning apparatus 4 in response to a functioning command received from the control unit 10 in the autonomous functioning apparatus 1 while the cooperative functioning apparatus camera 41 captures an external environment of the cooperative functioning apparatus 4 and the cooperative functioning apparatus 4 determines the traveling route by itself based on the image data obtained by the cooperative functioning apparatus camera 41. In this way, the cooperative functioning apparatus 4 functions in cooperation with the autonomous functioning apparatus 1.

### Third Embodiment

In the above-described embodiment, for example, referring to FIG. 2, examples have been described in which the control unit 10 of the autonomous functioning apparatus 1 and the cooperative control unit 20 of the cooperative functioning apparatus 2 are directly connected to the one remote communication device 13.

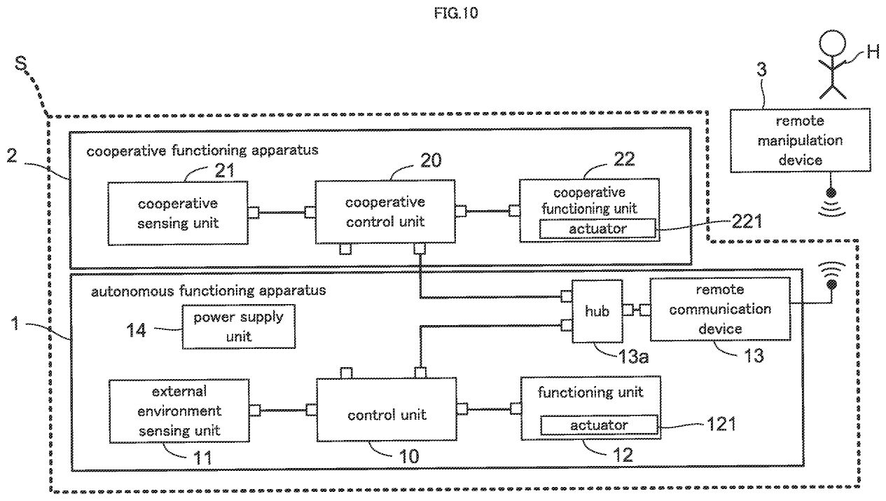

FIG. 10 is a block diagram showing a configuration of the autonomous functioning system including a control unit according to the third embodiment of the present teaching.

The autonomous functioning apparatus 1 in this third embodiment differs from the second embodiment in that it has a hub 13a. The autonomous functioning apparatus 1 in this third embodiment is not directly connected to the cooperative control unit 20, but is connected to the cooperative control unit 20 through the hub 13a.

Other points of this embodiment are the same as those of the second embodiment, and therefore the same reference numerals as those of the second embodiment are assigned to the respective portions.

The control unit 10 and the cooperative control unit 20 in FIG. 10 are connected to the one remote communication device 13 through the hub 13a. The hub 13a relays data among the control unit 10, the cooperative control unit 20, and the remote communication device 13. The control unit 10 and the cooperative control unit 20 connected to the hub 13a transmit data in a common transmission format.

The autonomous functioning apparatus 1 in FIG. 10 communicates with the cooperative control unit 20 through the hub 13a.

The hub 13a in this embodiment is an independent data mixing function out of the remote communication device 13 in the first embodiment. In other words, the hub 13a has a part of functions of the remote communication device 13. Thus, this embodiment can be seen as the embodiment in which the control unit 10 of the autonomous functioning apparatus 1 and the cooperative control unit 20 of the cooperative functioning apparatus 2 are connected to the one remote communication device 13.

In the second to third embodiments described above, examples of combinations of the one autonomous functioning apparatus 1 and the one cooperative functioning apparatus 2 are shown. However, the embodiments are not limited to those, and a plurality of cooperative functioning devices may be combined.

### Fourth Embodiment

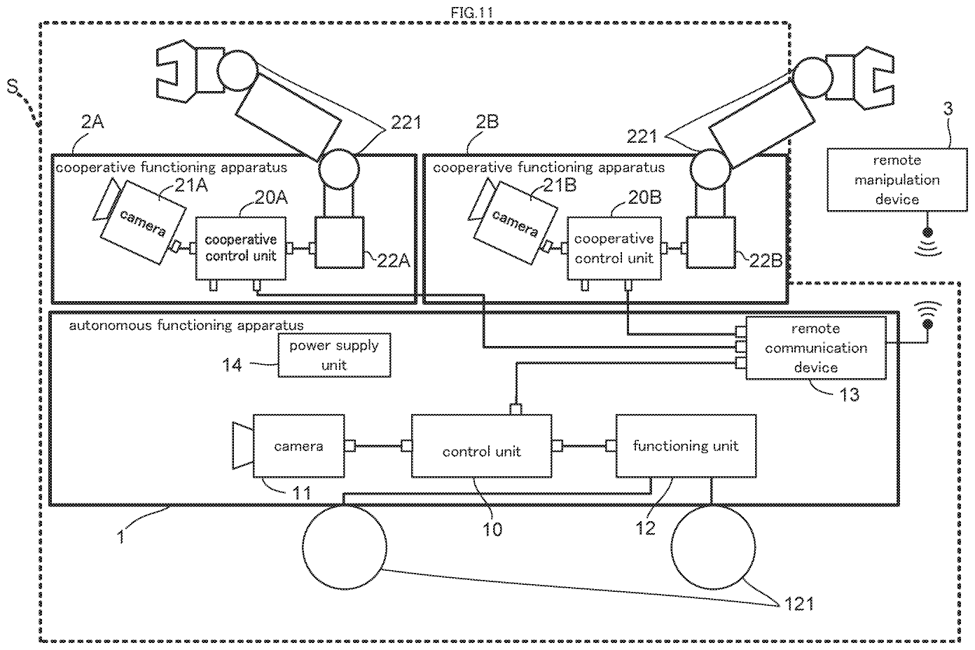

FIG. 11 is a block diagram showing a configuration of the autonomous functioning system including a control unit according to the fourth embodiment of the present teaching.

A plurality of cooperative functioning apparatus 2A and 2B are connected to the autonomous functioning apparatus 1 shown in FIG. 11.

Even when the plurality of cooperative functioning apparatus 2A and 2B are connected to the autonomous functioning apparatus 1, the remote communication device 13 receives image data from the external image-capturing camera 11, and outputs monitor image data to the remote manipulation device based on a signal outputted from the remote manipulation device 3, two cooperative control unit 20A and 20B, or a sensor represented by the external image-capturing camera 11 provided in the autonomous functioning apparatus.

In addition, the plurality of cooperative functioning apparatus 2A and 2B as well as the control unit 10 are connected to the remote communication device 13. Accordingly, image data outputted to the remote manipulation device 3 through the remote communication device 13 can be outputted in response to a signal detected by the remote manipulation device, the plurality of cooperative control unit 20A and 20B or a sensor represented by the external image-capturing camera 11 provided in the autonomous functioning apparatus 1.

### REFERENCE SIGNS LIST

1 autonomous functioning apparatus
2, 2′, 4 cooperative functioning apparatus
3 remote manipulation device
10 control unit
11 external environment sensing unit (external image-capturing camera)
12 functioning unit
13 remote communication device
14 power supply unit
20, 40 cooperative control unit
21, 41 cooperative sensing unit (cooperative functioning apparatus camera)
22, 42 cooperative functioning unit
40 cooperative control unit
110 external environment information connector (external image connector)
121 actuator
130 functioning control connector
140, 440 external communication connection part (external communication connector)
141 remote data connector
160 functioning control device
170 autonomous control circuit
171 GPU
171a control model
172 nonvolatile memory
180 monitoring circuit
181 FPGA
182 nonvolatile memory
184 relay
185 memory
221 actuator
S autonomous functioning system

1. A control unit for an autonomous functioning apparatus, the autonomous functioning apparatus having
a sensor provided therein,
an external image-capturing camera for capturing an external image of an external environment, and
an actuator,
and being autonomously functionable based on the external image and manipulable by operation of a remote manipulation device, the control unit being connected to a one remote communication device, the one remote communication device being connected to a cooperative control unit, which controls a cooperative functioning apparatus coupled to the autonomous functioning apparatus, and being communicatively connected to the remote manipulation device, the remote manipulation device being positioned outside both the autonomous functioning apparatus and the cooperative functioning apparatus,
the control unit comprising:
an external image connector for receiving external image data representing the external image captured by the external image-capturing camera;
a functioning control connector for outputting a functioning control signal for controlling functioning of the actuator;
an external communication connection part for exchanging data with the one remote communication device; and
a functioning control device for outputting monitor image data through the external communication connection part through the one remote communication device to the remote manipulation device, based on a signal outputted from:
the remote manipulation device,
the cooperative control unit, or
the sensor,
the monitor image data being based on the external image data received through the external image connector.

2. The control unit according to claim 1, wherein
the actuator provided in the autonomous functioning apparatus is a traveling device configured to drive the autonomous functioning apparatus, and
the functioning control device processes the external image data and generates the functioning control signal to determine a traveling course of the autonomous functioning apparatus.

3. The control unit according to claim 1, wherein
the functioning control device outputs the monitor image data based on:
a first signal received from the remote communication device through the external communication connection part, in response to a request for transmitting an image, the request being inputted from the remote manipulation device to the remote communication device,
a second signal received from the cooperative control unit, or
a third signal received from the sensor, the monitor image data being obtained by processing the external image data received from the external image-capturing camera, and having a smaller data size than the external image data.

4. The control unit according to claim 1, wherein
the functioning control device outputs the monitor image data based on:
a first signal received from the remote communication device through the external communication connection part, in response to a request for transmitting an image, the request being inputted from the remote manipulation device to the remote communication device,
a second signal received from the cooperative control unit, or
a third signal received from the sensor,
the monitor image data being obtained by compressing the external image data received from the external image-capturing camera, and having a smaller data size than the external image data.

5. The control unit according to claim 1, wherein
the functioning control device outputs the monitor image data based on:
a first signal received from the remote communication device through the external communication connection part, in response to a request for transmitting an image, the request being inputted from the remote manipulation device to the remote communication device,
a second signal received from the cooperative control unit, or
a third signal received from the sensor, the monitor image data being obtained by applying a frame thinning process on the external image data received from the external image-capturing camera, and having a smaller data size than the external image data.

6. The control unit according to claim 1, wherein
the functioning control device outputs the monitor image data based on:
a first signal received from the remote communication device through the external communication connection part, in response to a request for transmitting an image, the request being inputted from the remote manipulation device to the remote communication device,
a second signal received from the cooperative control unit, or
a third signal received from the sensor,
the monitor image data being obtained by applying a cropping process to extract a region of the external image from the external image data received from the external image-capturing camera, and having a smaller data size than the external image data.

7. The control unit according to claim 1, wherein the sensor and the external image-capturing camera in the autonomous functioning apparatus are a same device.

8. The control unit according to claim 1, wherein the cooperative functioning apparatus comprises a cooperative functioning apparatus camera that is connected to the cooperative control unit and outputs cooperative image data, representing another external image of the external environment captured by the cooperative functioning apparatus camera, wherein
the functioning control device selects data to be outputted to the remote manipulation device between
the external image data received through the external image connector, and
the cooperative image data received from the cooperative
functioning apparatus camera through the cooperative control unit, based on the signal outputted from:
the remote manipulation device,
the cooperative control unit, or
the sensor.

9. An autonomous functioning system that is autonomously functionable based on an external image of an external environment, and is remotely manipulable based on operation of a remote manipulation device, the autonomous functioning system comprising:
an autonomous functioning apparatus; and
a cooperative functioning apparatus coupled to the autonomous functioning apparatus, the cooperative functioning apparatus comprising a cooperative control unit for controlling the cooperative functioning apparatus, wherein
the autonomous functioning apparatus includes:
an external image-capturing camera provided in the autonomous functioning apparatus for capturing the external image,
a sensor provided in the autonomous functioning apparatus,
an actuator controlled based on the external image,
a remote communication device connected to the cooperative control unit, and communicatively connected to the remote manipulation device, and
a control unit connected to the remote communication device, the control unit comprising:
an external image connector for receiving external image data representing the external image captured by the external image-capturing camera,
a functioning control connector for outputting a functioning control signal for controlling functioning of the actuator,
an external communication connection part for exchanging data with the remote communication device, and
a functioning control device for outputting monitor image data through the remote communication device to the remote manipulation device based on a signal outputted from:
the remote manipulation device,
the cooperative control unit, or
the sensor, wherein
the monitor image data is obtained based on the external image data received through the external image connector, and
neither the autonomous functioning apparatus nor the cooperative functioning apparatus has the remote manipulation device positioned therein.
